(19) United States
(12) Patent Application Publication
(10) Pub. No.: US 2024/0125602 A1
(43) Pub. Date: Apr. 18, 2024

(54) SYSTEMS AND METHODS FOR TRIP DETECTION

(71) Applicant: GM GLOBAL TECHNOLOGY OPERATIONS LLC, Detroit, MI (US)

(72) Inventors: Daniel E. Rudman, West Bloomfield, MI (US); Jeffrey A. Phelan, Chandler, AZ (US); Nicholas T. Mason, JR., Hutto, TX (US); Nathaniel James Reline-Martin, Chandler, AZ (US); James Scott MacGuidwin, Northville, MI (US); Daniel Schleuger, Marietta, GA (US)

(73) Assignee: GM GLOBAL TECHNOLOGY OPERATIONS LLC, Detroit, MI (US)

(21) Appl. No.: 18/047,478

(22) Filed: Oct. 18, 2022

(51) Int. Cl. G01C 21/28

(52) U.S. Cl. CPC G01C 21/28

(57) ABSTRACT

Methods and systems are provided for detecting a trip of a user in a vehicle. A method includes: receiving by a processor of a user device, device scan data from one or more communication enabled devices; determining, by the processor, whether the devices listed in the device scan data is a vehicle device; in response to the determining, identifying, by the processor, the vehicle device as a found device; determining, by the processor, whether the found device is listed in a known device list; and generating, by the processor, at least one of a trip start signal and a trip end signal based on whether the found device is listed in the known device list.

### INTRODUCTION

The present disclosure generally relates to vehicles, and more particularly relates to systems and methods for detecting a trip by user with a vehicle.

A trip is defined as a session of travel or a session of intended travel by a user within a vehicle. Knowing when a trip starts and a trip ends is useful for many applications including ride monitoring applications such as crash detection and analysis applications, insurance applications, energy management applications, ride sharing applications, taxi applications, etc.

Some methods of determining a trip start and a trip end may use time, speed, location, and/or acceleration information from the vehicle and/or a mobile device. For example, a trip start may be determined when a vehicle reaches a minimum speed threshold, and a trip end may be determined when that vehicle reaches a speed of zero for more than some number of minutes (allowing sufficient time to not be confused by most long traffic signals). This method is imperfect because of traffic stops, slow traffic zones, and the first portion of the trip can be missed. In another example, using the location, speed, and/or acceleration of a mobile device to determine that a mobile phone is moving with someone or something walking, riding a bike, riding a motorcycle, riding car/truck, etc. requires a user to allow certain permissions from the mobile device to continually be on to detect a start and an end. This method is also prone to false positives and inaccuracies due to misinterpreting sensor data.

Accordingly, it is desirable to provide improved methods and systems for detecting a trip start and a trip end by a user of a vehicle. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for detecting a trip of a user in a vehicle. A method includes: receiving by a processor of a user device, device scan data from one or more communication enabled devices; determining, by the processor, whether the devices listed in the device scan data is a vehicle device; in response to the determining, identifying, by the processor, the vehicle device as a found device; and determining, by the processor, whether the found device is listed in a known device list; and generating, by the processor, at least one of a trip start signal and a trip end signal based on whether the found device is listed in the known device list.

In various embodiments, when the found device is not listed in the known device list, the method includes performing an alternative trip start detection method, and wherein the generating the trip start signal is based on the alternative trip start detection method.

In various embodiments, the alternative trip start detection method is based on at least one of a speed and/or time method, an activity recognition, a Bluetooth connection detection, and an external application integration.

In various embodiments, the method includes updating the known device list with found devices commonly stored in a trip device list.

In various embodiments, the method includes performing an alternative trip end detection method, and wherein the generating the trip end signal is based on the alternative trip end detection method.

In various embodiments, the alternative trip end detection method is based on at least one of a speed and/or time method, an activity recognition, a Bluetooth connection detection, and an external application integration.

In various embodiments, the generating the at least one of the trip start signal and the trip end signal includes generating the trip end signal when a trip device list is empty

In various embodiments, the generating the at least one of the trip start signal and the trip end signal comprises generating the trip start signal when the found device is a known device and listed in the known device list.

In various embodiments, the generating the at least one of the trip start signal and the trip end signal comprises generating the trip end signal when the known device is no longer the found device.

In various embodiments, the method includes performing a scan for Bluetooth communication devices, and wherein the receiving is in response to the scan.

In another embodiments, a system includes: a memory of a user device, the memory storing instructions configured to perform a method. The method includes: receiving, device scan data from one or more communication enabled devices; determining whether the devices listed in the device scan data is a vehicle device; in response to the determining, identifying the vehicle device as a found device; and determining whether the found device is listed in a known device list; and generating at least one of a trip start signal and a trip end signal based on whether the found device is listed in the known device list.

In various embodiments, when the found device is not listed in the known device list, the method includes performing an alternative trip start detection method, and wherein the generating the trip start signal is based on the alternative trip start detection method.

In various embodiments, the alternative trip start detection method is based on at least one of a speed and/or time method, an activity recognition, a Bluetooth connection detection, and an external application integration.

In various embodiments, the method includes updating the known device list with found devices commonly stored in a trip device list.

In various embodiments, the method includes performing an alternative trip end detection method, and wherein the generating the trip end signal is based on the alternative trip end detection method.

In various embodiments, the alternative trip end detection method is based on at least one of a speed and/or time method, an activity recognition, a Bluetooth connection detection, and an external application integration.

In various embodiments, the generating the at least one of the trip start signal and the trip end signal includes generating the trip end signal when a trip device list is empty.

In various embodiments, the generating the at least one of the trip start signal and the trip end signal comprises generating the trip start signal when the found device is a known device and listed in the known device list.

In various embodiments, the generating the at least one of the trip start signal and the trip end signal comprises generating the trip end signal when the known device is no longer the found device.

In various embodiments, the method includes performing a scan for Bluetooth communication devices, and wherein the receiving is in response to the scan.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a transportation system having one or more vehicles associated with at least one mobile user device configured to perform trip detection, in accordance with various embodiments;

FIG. 2 is a functional block diagram of components of an exemplary user device, in accordance with various embodiments;

FIG. 3 is a dataflow diagram illustrating a trip detection system of the user device, in accordance with various embodiments; and

FIG. 4 is a flowchart illustrating a trip detection method that may be performed by the user device, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

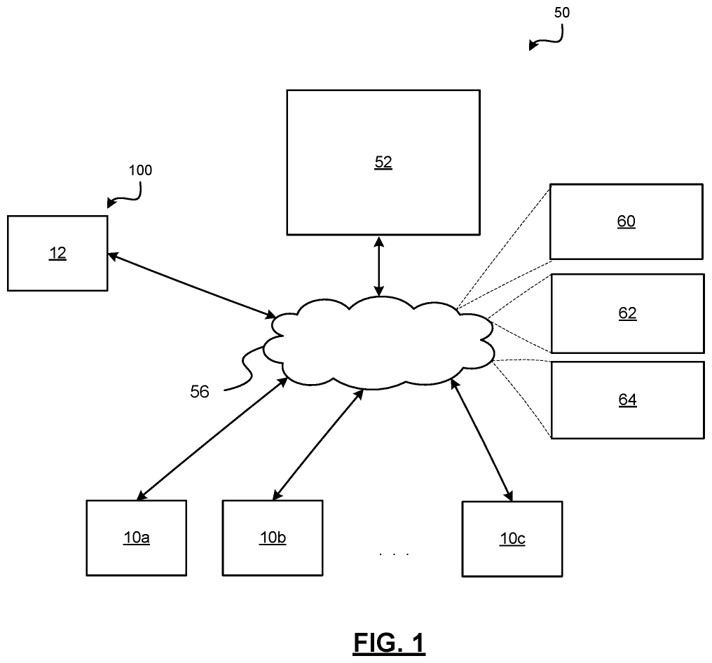

With reference to FIG. 1, a trip detection system shown generally at 100 is associated with a user device 12 and at least one vehicle 10 enabled with a communication device. In various embodiments, the communication device is a Bluetooth communication device or other short range communication device configured to communicate a device type and/or identification. The trip detection system 100 detects a trip start and a trip end based on scans for discoverable communication enabled vehicles (referred to as found vehicles) within proximity to the vehicle 10. As will be discussed in more detail, the trip detection system 100 builds a profile for commonly discovered vehicles for an individual associated with the mobile device, and then begins to determine a trip start and a trip end based on that profile and detected surrounding communication enabled vehicles.

In various embodiments, the vehicle 10 and user device 12 may be suitable for use in the context of a single user vehicle and a taxi or shuttle system in a certain geographical area (e.g., a city, a school or business campus, a shopping center, an amusement park, an event center, or the like) or may simply be managed by a remote system. For example, the vehicle 10 may be associated with a remote transportation system 52 or other entity that is configured to monitor trip information. FIG. 1 illustrates an exemplary embodiment of an operating environment shown generally at 50 that includes the remote transportation system 52 that is associated with the mobile device 12 and one or more vehicles 10a-10n. In various embodiments, the operating environment 50 further includes one or more user devices 12 that communicate with the vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site, or they could be remotely located from one another, each base station could be responsible for a single cell tower, or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 12 is shown in FIG. 1, embodiments of the operating environment 50 can support any number of user devices 12, including multiple user devices 12 owned, operated, or otherwise used by one person. Each user device 12 supported by the operating environment 50 may be implemented using any suitable hardware platform. In this regard, the user device 12 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like.

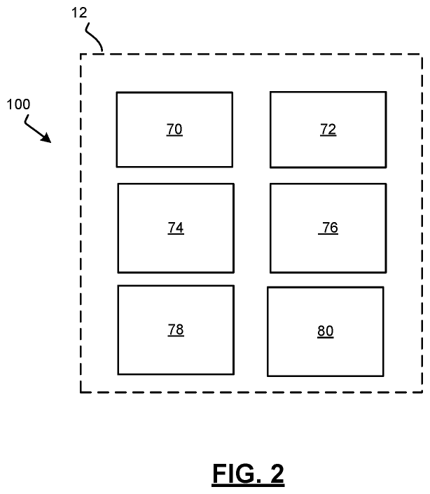

As shown in FIG. 2, each user device 12 supported by the operating environment 50 is realized as a computer-implemented or computer-based device having the hardware, software, firmware, and/or processing logic needed to carry out the various techniques and methodologies described herein. For example, the user device 12 includes a processor 70, memory 72, one or more input/output (I/O) devices 74, a global positioning system (GPS) device 76, a communication device 78, and other communication devices 80.

In various embodiments, the processor 70, is a programmable device that includes one or more instructions stored in or associated with the memory 72. In various embodiments, the trip detection system 100 is stored as an application in the memory 72 and executed by the processor 70.

In various embodiments, the I/O devices 74 include a visual display, touch sensors, and/or or other sensory devices configured to communicate with a user of the user device 12. The GPS device 76 is configured to receive GPS satellite signals and generate GPS coordinates and other information based on those signals. The communication device 80 is configured to perform cellular and/or Wi-Fi communications functionality such that the device carries out voice and/or data communications over the communication network 56 using one or more long range communication protocols. The communication device 78 is configured to scan for other short range devices and in some instances communicate using, for example, Bluetooth or other short-range communication protocols.

With reference back to FIG. 1, the remote transportation system 52 includes one or more backend server systems, which may be cloud-based, network-based, or resident at the particular campus or geographical location serviced by the remote transportation system 52. The remote transportation system 52 can be manned by a live advisor, or an automated advisor, or a combination of both. The remote transportation system 52 can communicate with the user devices 54 and the vehicles 10a-10n to schedule rides, dispatch the vehicles 10a-10n, and/or analyze data. In various embodiments, the remote transportation system 52 stores account information such as subscriber authentication information, vehicle identifiers, profile records, behavioral patterns, and other pertinent subscriber information.

As can be appreciated, the subject matter disclosed herein provides certain enhanced features and functionality to what may be considered as a standard or baseline user device 12, vehicle 10, and/or remote transportation system 52. To this end, a user device 12, a vehicle 10, and/or a remote transportation system 52 can be modified, enhanced, or otherwise supplemented to provide the additional features described in more detail below.

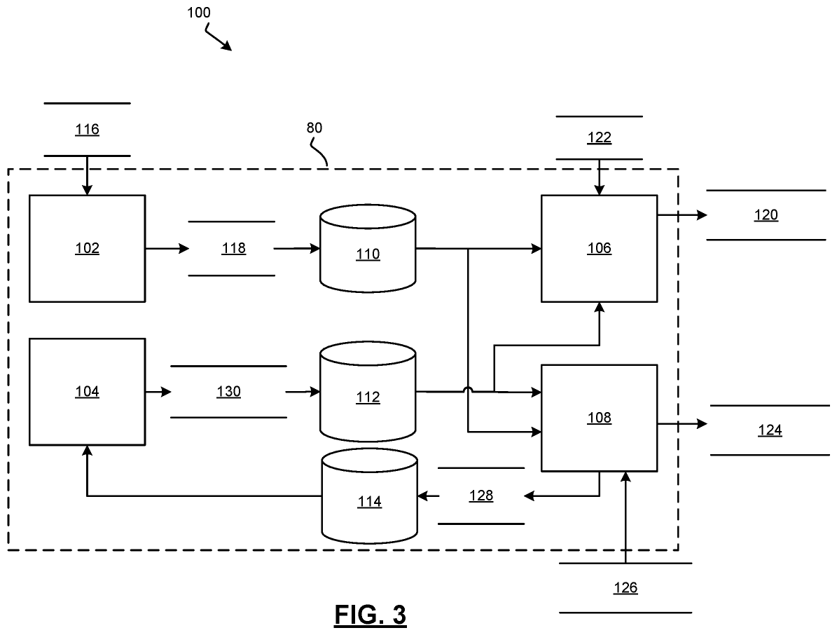

With reference now to FIG. 3, a dataflow diagram illustrates elements of the trip detection system 100 that may be implemented by the user device 12, the vehicles 10a-10n, and/or the remote transportation system 52. As can be appreciated, various embodiments of the trip detection system 100 according to the present disclosure may include any number of modules which may be combined and/or further partitioned to similarly implement systems and methods described herein. Furthermore, inputs to the trip detection system 100 may be received from the I/O devices 74, the communication device 80, and/or the communication device 78. Furthermore, the inputs might also be subjected to preprocessing, such as sub-sampling, noise-reduction, normalization, feature-extraction, missing data reduction, and the like. In various embodiments, the trip detection system 100 includes a device scan module 102, a known device determination module 104, a trip start determination module 106, a trip end determination module 108, a found device list datastore 110, a known device list datastore 112, and a trip device list datastore 114.

In various embodiments, the device scan module 102 receives as input device data 116. The device data 116 is received in response to a scan performed by the communication device 78, and/or the communication device 80. For example, the device scan module 102 initiates a scan of all Bluetooth devices via the communications device 78 and received the device data 116 in response. The device scan module 102 evaluates the device data 116 for local devices identified as “vehicles” (e.g., a textual label or other identifier that indicates that the local device is a vehicle). For each device identified as a “vehicle,” the device scan module 102 stores found device data 118 in the found device list datastore 110.

In various embodiments, the trip start determination module 106 evaluates the found device list stored in the found device list datastore 110. The trip start determination module 106 compares the found device list with a known device list stored in the known device list datastore 112. When the found device is a known device, the trip start determination module 106 generates a trip start signal 120.

Alternatively, when the found device is not a known device, the trip start determination module 106 evaluates movement data 122 to determine when a trip has started. For example, using alternative means such as speed and/or time methods, activity recognition, Bluetooth connection detection, or other external application integration, the trip start determination module 106 determines when to generate the trip start signal 120.

In various embodiments, the trip end determination module 108 evaluates the found device list to determine if the known device(s) is still detected. Once the known device is no longer a found device, the trip end determination module 108 generates a trip end signal 124.

Alternatively, when the found device was not a known device, the trip end determination module 108 evaluates movement data 126 to determine when a trip has ended For example, using alternative means such as speed and/or time methods, activity recognition, Bluetooth connection detection, and/or other external application integration, the trip end determination module 108 determines when to generate the trip end signal 124.

In various embodiments, the trip end determination module 108 module stores all of the found devices between the trip start and the trip end as trip device data 128 in the trip device list of the trip device list datastore 114.

In various embodiments, the known device determination module 104 evaluates the trip device list to determine the known devices. For example, the known device determination module 104 stores the most frequently found devices from the trip device list as known device 130 in the known device list of the known device list datastore 112.

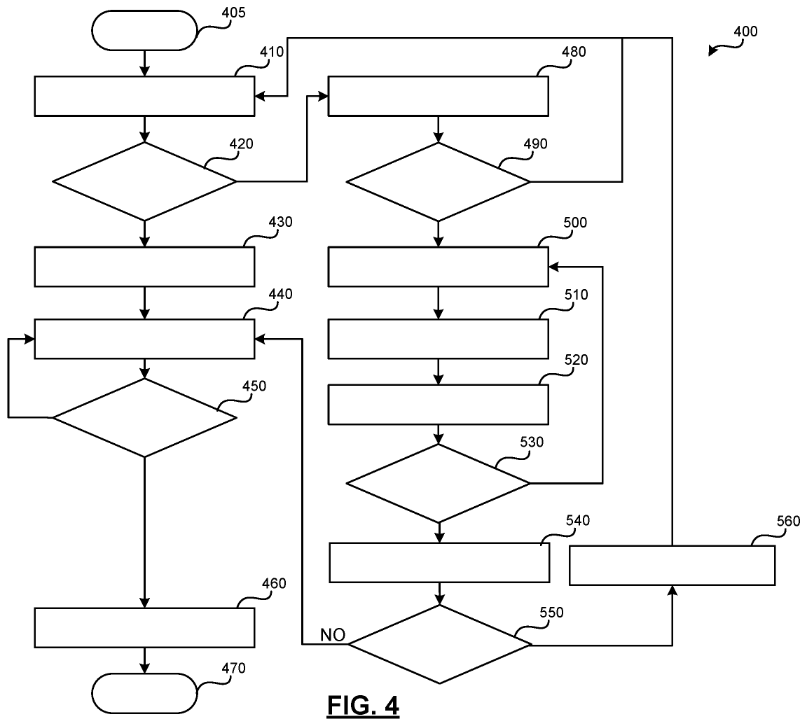

Referring now to FIG. 4, and with continued reference to FIGS. 1-3, a flowchart illustrates a method 400 that can be performed by the trip detection system 100 of FIGS. 1-3 in accordance with the present disclosure. As can be appreciated in light of the disclosure, the order of operation within the method is not limited to the sequential execution as illustrated in FIG. 4, but may be performed in one or more varying orders as applicable and in accordance with the present disclosure. In various embodiments, the method 400 can be scheduled to run based on one or more predetermined events, and/or can run continuously during operation of user device 12.

In one example, the method may begin at 405 when the application is started on the user device 12 or as the user is preparing for a trip (e.g., getting keys, walking to a car, etc.). discoverable devices, such as Bluetooth devices, advertising as “vehicles” are scanned for at 410 and identified as found devices in the found device list. The found device list is compared with a known device list at 420. When the found devices are listed in the known device list at 420, a trip start is signaled at 430.

Thereafter, discoverable devices advertising as “vehicles” are scanned for and the found device list is generated at 440. The found device list is evaluated to determine if the known device is still detected at 450. Once the known device is no longer found at 450, a trip end is signaled at 460. Thereafter, the method 400 may end 470.

At 420, when the found devices are not listed in the known device list, an alternative trip start detection is performed at 480 using alternative means such as speed and/or time methods, activity recognition, Bluetooth connection detection, or other external application integration.

Once the trip start is detected at 490, discoverable devices advertising as “vehicles” are scanned for and are identified as found devices at 500. The found devices are saved to the trip device list at 510. Alternate trip end detection is performed at 520 by alternative means such as speed and/or time methods, activity recognition, Bluetooth connection detection, or other external application integration. If the trip is not detected at 530, the method continues to scan for devices at 500.

Once the trip end is detected at 530, the most frequently found devices from the trip device list is stored in the known device list at 540. If there are no devices in the trip device list at 550, the method 400 generates a trip end signal at 560 and returns to scanning for discoverable devices advertising as “vehicles” at 410.

If there are devices in the trip device list at 550, the method 400 remains in trip start and discoverable devices advertising as “vehicles” are scanned for and the found device list is generated at 440. The method 400 continues until the known device is no longer detected at 450 and the trip end signal is generated at 460. Thereafter, the method 400 may end at 470.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for detecting a trip of a user in a vehicle, comprising:
receiving by a processor of a user device, device scan data from one or more communication enabled devices;
determining, by the processor, whether the devices listed in the device scan data is a vehicle device;
in response to the determining, identifying, by the processor, the vehicle device as a found device; and
determining, by the processor, whether the found device is listed in a known device list; and
generating, by the processor, at least one of a trip start signal and a trip end signal based on whether the found device is listed in the known device list.

2. The method of claim 1, further comprising when the found device is not listed in the known device list, performing an alternative trip start detection method, and wherein the generating the trip start signal is based on the alternative trip start detection method.

3. The method of claim 2, wherein the alternative trip start detection method is based on at least one of a speed and/or time method, an activity recognition, a Bluetooth connection detection, and an external application integration.

4. The method of claim 1, further comprising updating the known device list with found devices commonly stored in a trip device list.

5. The method of claim 2, further comprising performing an alternative trip end detection method, and wherein the generating the trip end signal is based on the alternative trip end detection method.

6. The method of claim 5, wherein the alternative trip end detection method is based on at least one of a speed and/or time method, an activity recognition, a Bluetooth connection detection, and an external application integration.

7. The method of claim 5, wherein the generating the at least one of the trip start signal and the trip end signal comprises generating the trip end signal when a trip device list is empty.

8. The method of claim 1, wherein the generating the at least one of the trip start signal and the trip end signal comprises generating the trip start signal when the found device is a known device and listed in the known device list.

9. The method of claim 8, wherein the generating the at least one of the trip start signal and the trip end signal comprises generating the trip end signal when the known device is no longer the found device.

10. The method of claim 1, further comprising performing a scan for Bluetooth communication devices, and wherein the receiving is in response to the scan.

11. A system for detecting a trip of a user in a vehicle, comprising:
a memory of a user device, the memory storing instructions configured to perform a method, the method comprising:
receiving, device scan data from one or more communication enabled devices;
determining whether the devices listed in the device scan data is a vehicle device;
in response to the determining, identifying the vehicle device as a found device; and
determining whether the found device is listed in a known device list; and
generating at least one of a trip start signal and a trip end signal based on whether the found device is listed in the known device list.

12. The system of claim 11, further comprising when the found device is not listed in the known device list, performing an alternative trip start detection method, and wherein the generating the trip start signal is based on the alternative trip start detection method.

13. The system of claim 12, wherein the alternative trip start detection method is based on at least one of a speed and/or time method, an activity recognition, a Bluetooth connection detection, and an external application integration.

14. The system or claim 11, further comprising updating the known device list with found devices commonly stored in a trip device list.

15. The system of claim 12, further comprising performing an alternative trip end detection method, and wherein the generating the trip end signal is based on the alternative trip end detection method.

16. The system of claim 15, wherein the alternative trip end detection method is based on at least one of a speed and/or time method, an activity recognition, a Bluetooth connection detection, and an external application integration.

17. The system of claim 15, wherein the generating the at least one of the trip start signal and the trip end signal comprises generating the trip end signal when a trip device list is empty.

18. The system of claim 11, wherein the generating the at least one of the trip start signal and the trip end signal comprises generating the trip start signal when the found device is a known device and listed in the known device list.

19. The system of claim 18, wherein the generating the at least one of the trip start signal and the trip end signal comprises generating the trip end signal when the known device is no longer the found device.

20. The system of claim 11, further comprising performing a scan for Bluetooth communication devices, and wherein the receiving is in response to the scan.
